(19) United States
(12) Patent Application Publication
(10) Pub. No.: US 2013/0108396 A1
(43) Pub. Date: May 2, 2013

(54) NAIL STRUCTURE

(71) Applicant: Ying-Feng Hung, Changhua (TW)

(72) Inventor: Ying-Feng Hung, Changhua (TW)

(73) Assignee: YEUN CHANG HARDWARE TOOL CO., LTD., CHANGHUA (TW)

(21) Appl. No.: 13/284,905

(22) Filed: Oct. 30, 2011

(51) Int. Cl. F16B 15/00

(52) U.S. Cl. 411/451.1

(57) ABSTRACT

A nail structure has a main body having a long section with a slantedly threaded surface. One end of the main body forms a sharp end, while the other end there of has an enlarging ring end with cone shape. Also, the other end of the main body has a head end, and a neck section is formed between the head end and the ring end. When the main body pokes through a fixed unit to attach the fixed unit to a wall surface or structure, the long section is in an engaging status due to the threads on the long section surface, and when the ring end is inserted into the wall or structure, it generates a stopping effect so that the main body of the nail cannot be easily pulled out. Also, the head end is restricted by the fixed unit towards the wall or structure to secure the fixed unit.

### FIELD OF THE INVENTION

The present invention relates to a nail structure, and more particularly refers to a nail structure that provides a more stable engaging status to prevent a fixed item from falling off.

### BACKGROUND OF THE INVENTION

A conventional nail structure can be seen in FIGS. 13 and 14. The conventional nail structure includes a body (30) that forms a head element (31) on one side, and a sharp element (32) on the other side. Features of the conventional nail structure are: when the body (30) is close to the head element (31) to form an enlarging ring edge (33) and tapered to form a head rod (34) with an appropriate length, so that the head rod (34) and the ring edge (33) forms a ring stopping edge (35) at the junction. Thus, when the nail is hammered into a fixed item (36), it is more stable and neat.

However, according to the conventional nail structure, it is disadvantageous that the sharp element (32) of the body (30) pokes through the fixed item (36) to attach the fixed item to the wall, and uses the ring edge (33) to generate a stopping effect to prevent the fixed item (36) from falling off. However, surface of the sharp element (32) to the ring edge (33) of the body (30) is smooth and it has nothing to do with an inner portion of the wall in addition to contact, so the body (30) can be easily pulled out by an external force and the fixed item (36) would detach from the wall surface accordingly. Therefore, a new and improved nail structure is needed to address the disadvantages illustrated above.

### SUMMARY OF THE INVENTION

The technical problem the present invention wants to solve is that the sharp element of the body pokes through the fixed item to attach the fixed item to the wall, and uses the ring edge to generate a stopping effect to prevent the fixed item from falling off. However, surface of the sharp element to the ring edge of the body is smooth and it has nothing to do with an inner portion of the wall in addition to contact, so the body can be easily pulled out by an external force and the fixed item would detach from the wall surface accordingly.

The technical point to solve the problem above is that the present invention has a main body having a long section and surface of which is slantedly threaded. One end of the main body forms a sharp end, while the other end there of has an enlarging ring end with cone shape. Also, the other end of the main body has a head end, and a neck section is formed between the head end and the ring end, and a nail structure for various boards is accordingly formed.

Comparing with prior arts, when the main body passes through the fixed unit to attach to the wall or structure, the slanting threads on the long section generates an engaging status. Also, when the ring end is inserted into the wall or structure, it provides a stopping effect, so that the main body is not easy to pull out from the wall or structure. The head end is restricted by the fixed unit towards the wall or structure, so the fixed unit can be securely fixed to enhance the practicability of the nail structure.

### BRIEF DESCRIPTION OF THE DRAWINGS

FIG. 1 illustrates a three-dimensional view in the present invention.

FIG. 2 illustrates a lateral view in front and back of one embodiment in the present invention.

FIG. 3 illustrates a schematic view of the present invention when in use.

FIG. 4 illustrates a second schematic view of the present invention when in use.

FIG. 5 illustrates a third schematic view of the present invention when in use.

FIG. 6 illustrates a fourth schematic view of the present invention when in use.

FIG. 7 illustrates a fifth schematic view of the present invention when in use.

FIG. 8 illustrates a sixth schematic view of the present invention when in use.

FIG. 9 illustrates a schematic view in the present invention of another practical usage.

FIG. 10 illustrates a preferred embodiment in the present invention.

FIG. 11 illustrates a schematic view of the preferred embodiment when in use in the present invention.

FIG. 12 illustrates a second schematic view of the preferred embodiment when in use in the present invention.

FIG. 13 illustrates a three-dimensional view of a prior art.

FIG. 14 illustrates a schematic view of a prior art when in use.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

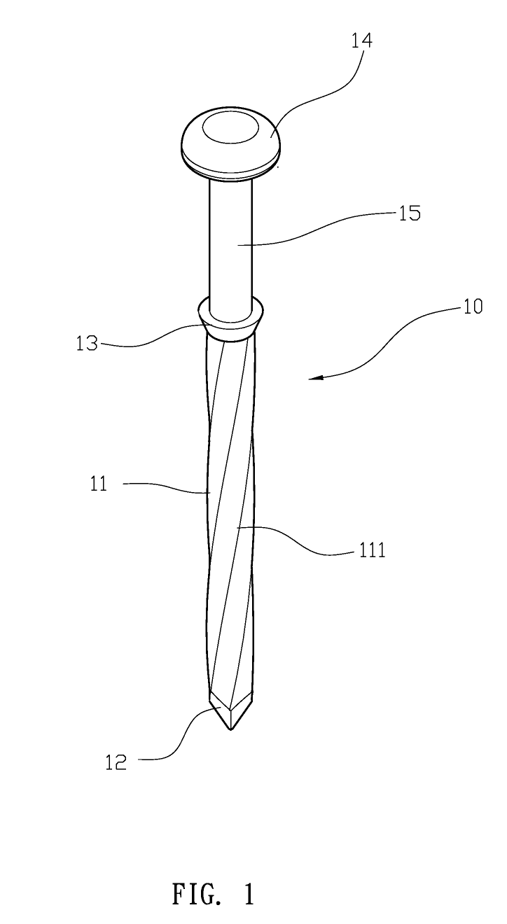

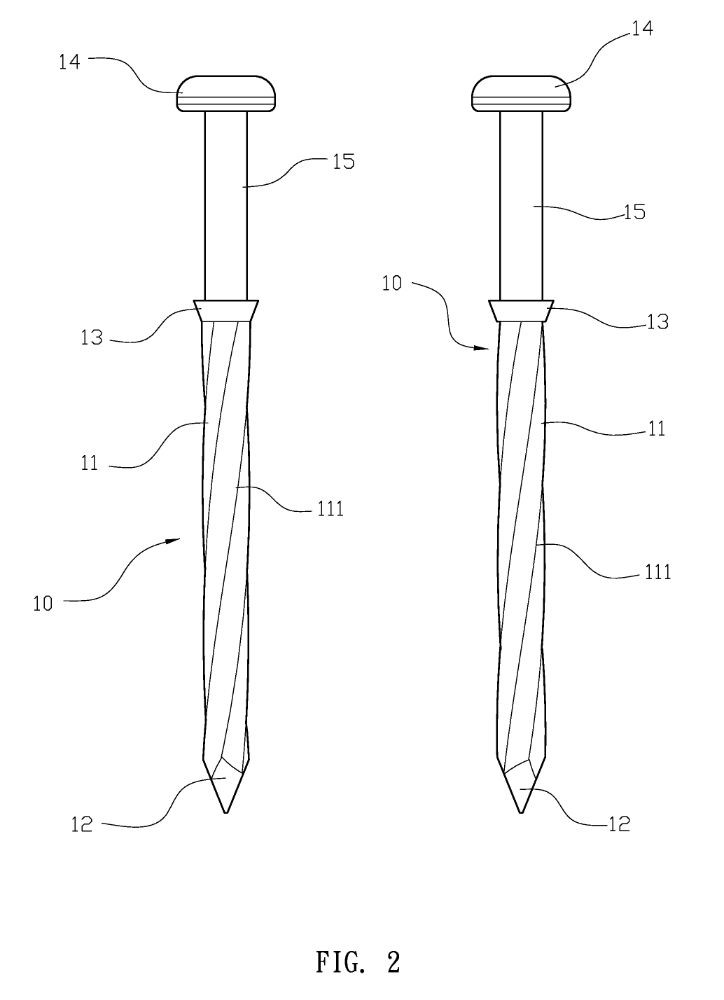

Referring to FIGS. 1 and 2, a nail for plywood includes a main body (10) that has a long section (11) having slanting threads (111) on its outer surface, and has a sharp end (12) on the other side. The other side of the long section (11) has a gradually enlarged ring end (13) with cone-shape. The other side of the main body (10) has a head end (14) that connects with the ring end (13) with a neck section (15), the length of which is determined corresponding to the thickness of a fixed unit (20).

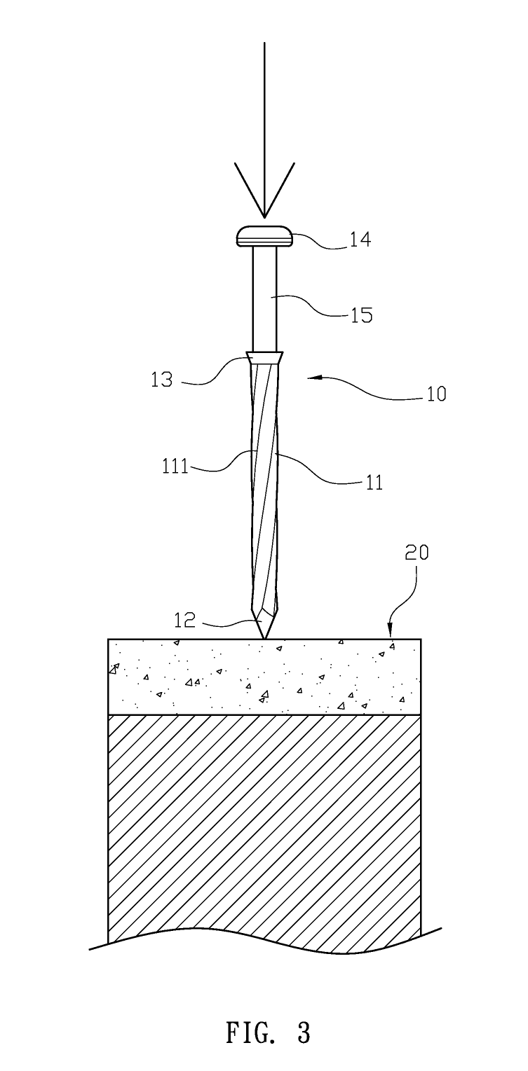

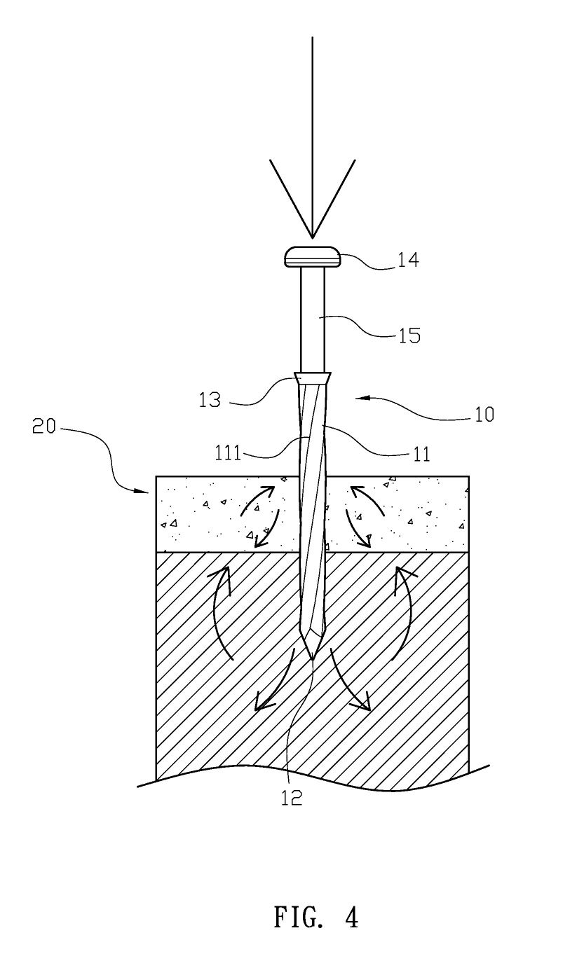

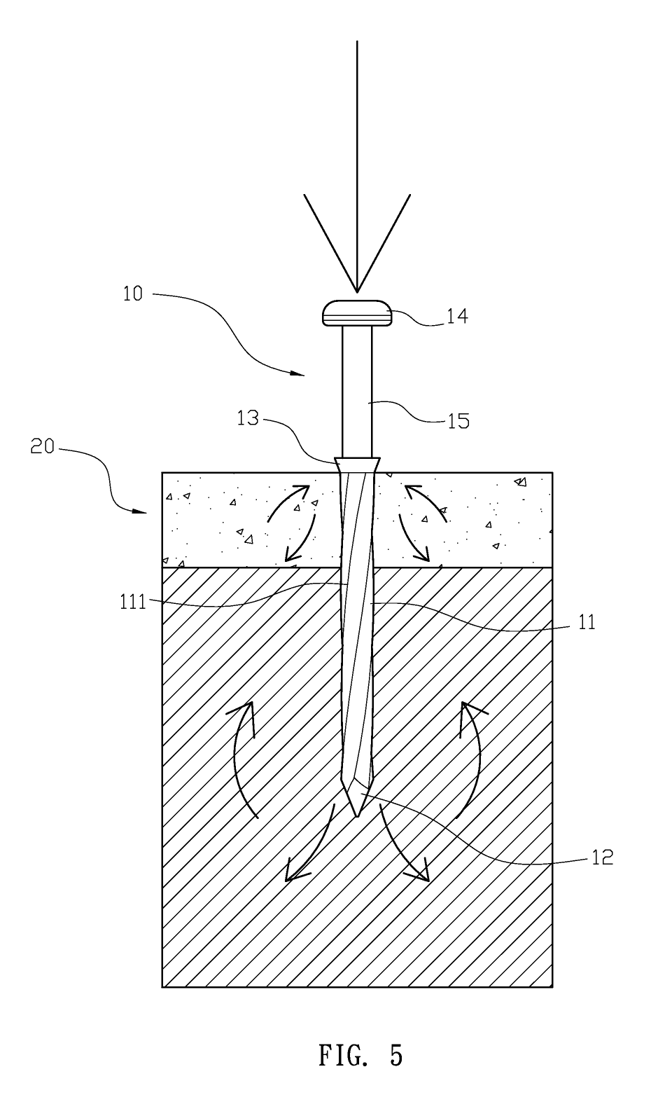

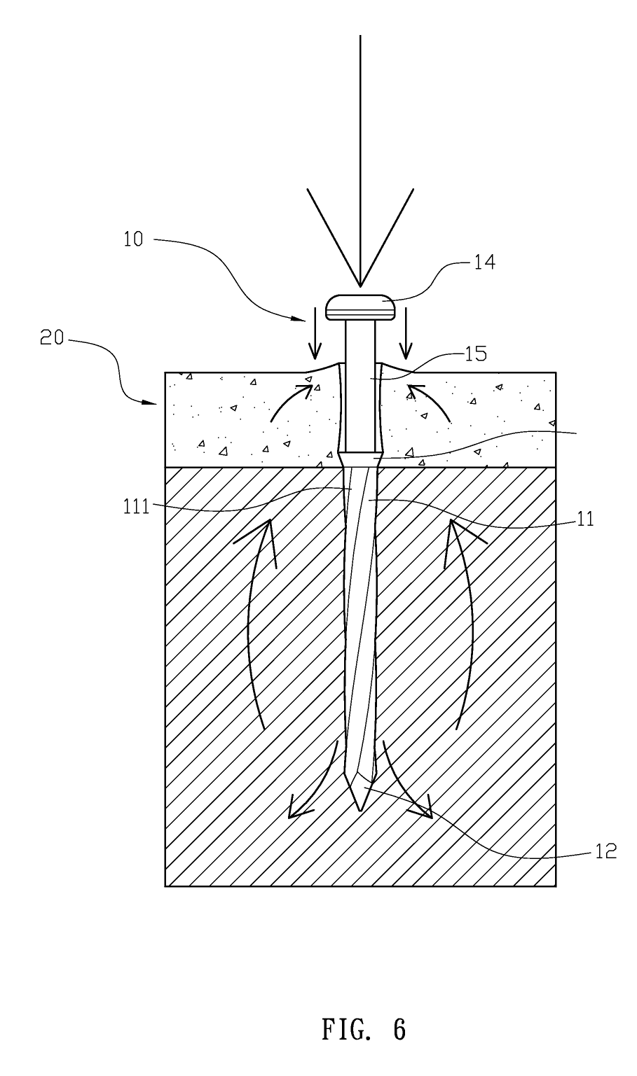

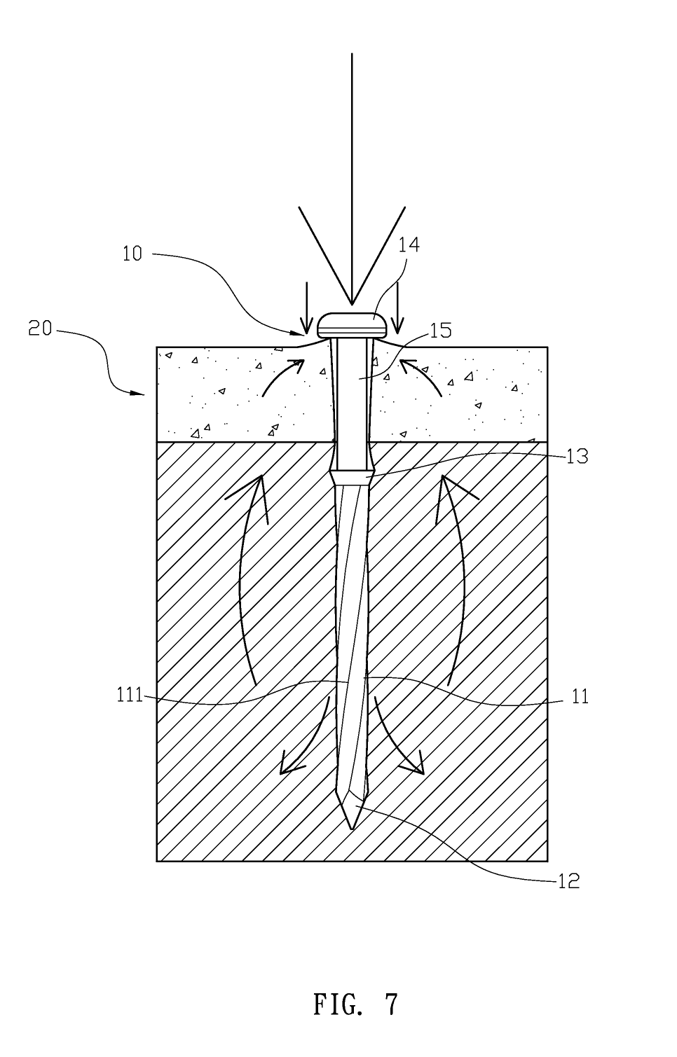

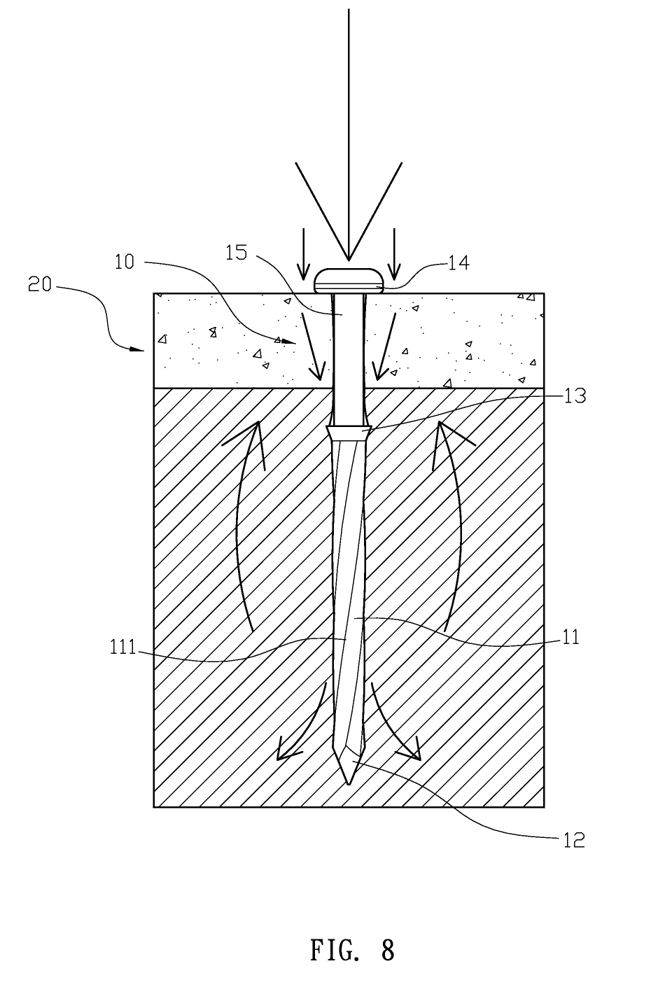

Referring to FIGS. 2-6, the main body (10) is provided for structure of RC steel wall or light steel. When in use, the fixed unit (20) is attached to a wall surface or structure, and the sharp end (12) of the main body (10) is disposed on the surface of the fixed unit (20), and is hammered in by a hammer, so that the long section (11) pokes through the fixed unit (20) inside the wall or structure through the slanting threads (111), and when the ring end (13) of the other side end of the long section (11) passes through the fixed unit (20), it can be implanted into the wall or structure due to a tapered surface of the ring end (13) when passing through the fixed unit (20), and the neck section (15) can be inserted in the fixed unit (20). At this time, the neck section (15) can be enclosed by resilient element of the fixed unit (20) (see FIG. 7) to form a restricting effect when the ring end (13) is implanted in the wall or structure to prevent the main body (10) from falling off due to an external force. The head end (14) is hammered to an outer surface of the fixed unit (20) (see FIG. 8), so the fixed unit (20) can be fixed on the RC steel wall or light steel structure through the slanting threads (111) of the long section (11) and engaged with each other, and the ring end (13) is restricted in the wall to provide a better way to fix the fixed unit (20).

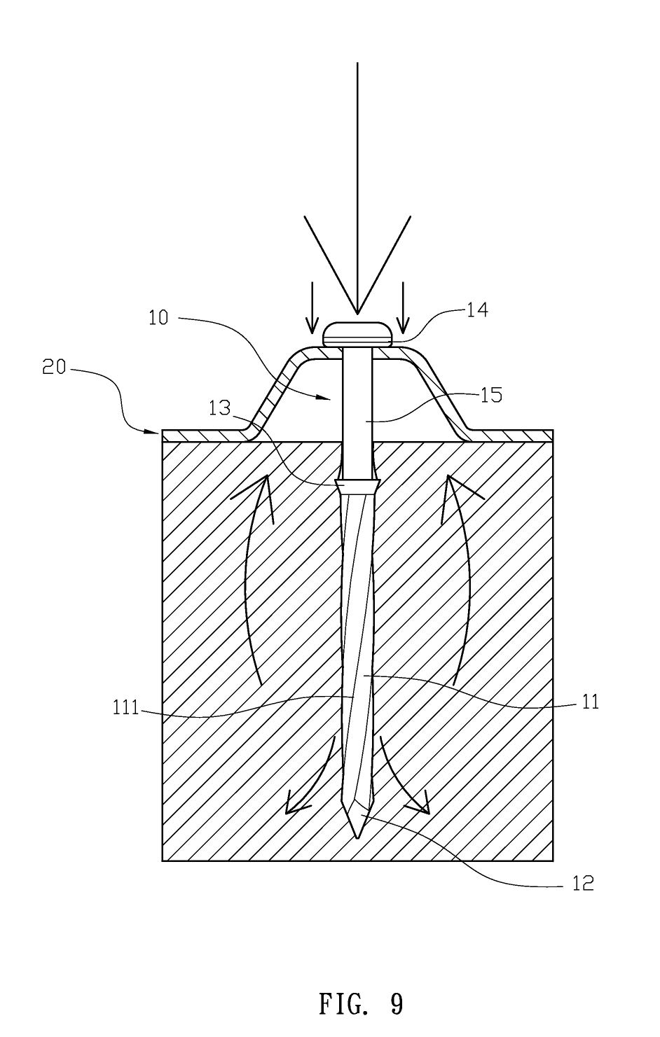

In another embodiment shown in FIG. 9, the main body (10) can be used in the assembly of a board structure. In FIG. 9, the fixed unit (20) is a wave board that is put on a wall surface or structure with its flat portion, and the main body (10) is hammered into a bulged portion of the wave board, so the long section (11) and the ring end (13) pass through the fixed unit (20) into the wall or structure and the threads of the long section (11) are engaged therein. The ring end (13) is restricted in the wall or structure to generate a stopping effect and the other side of the main body (10), the head end (14), is finally disposed on the bulged surface of the wave board to securely attach the wave board onto the wall or structure.

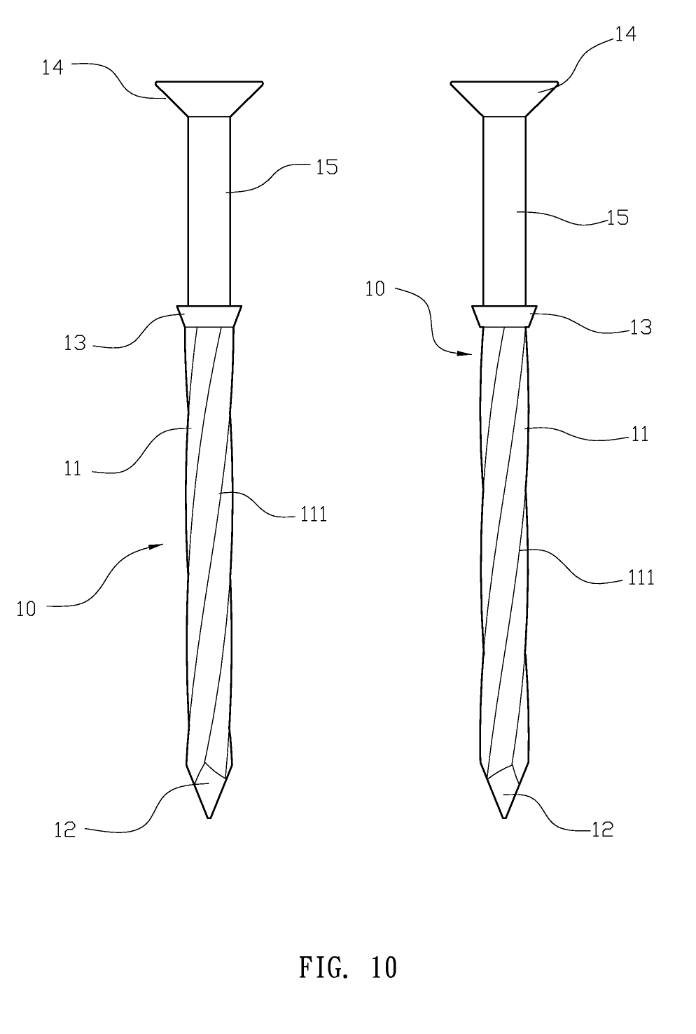

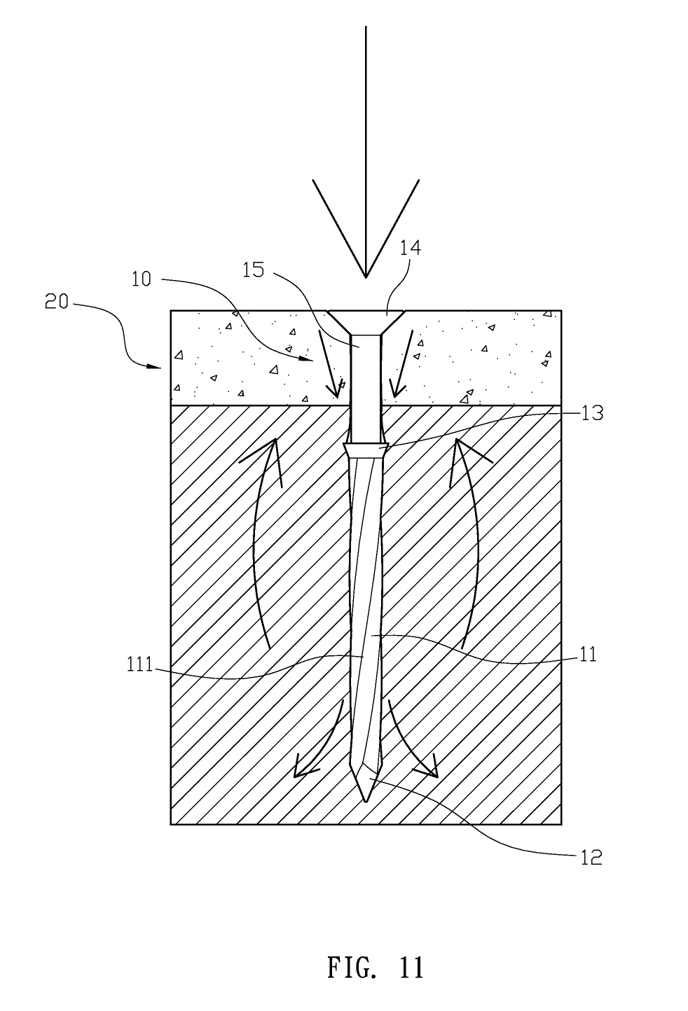

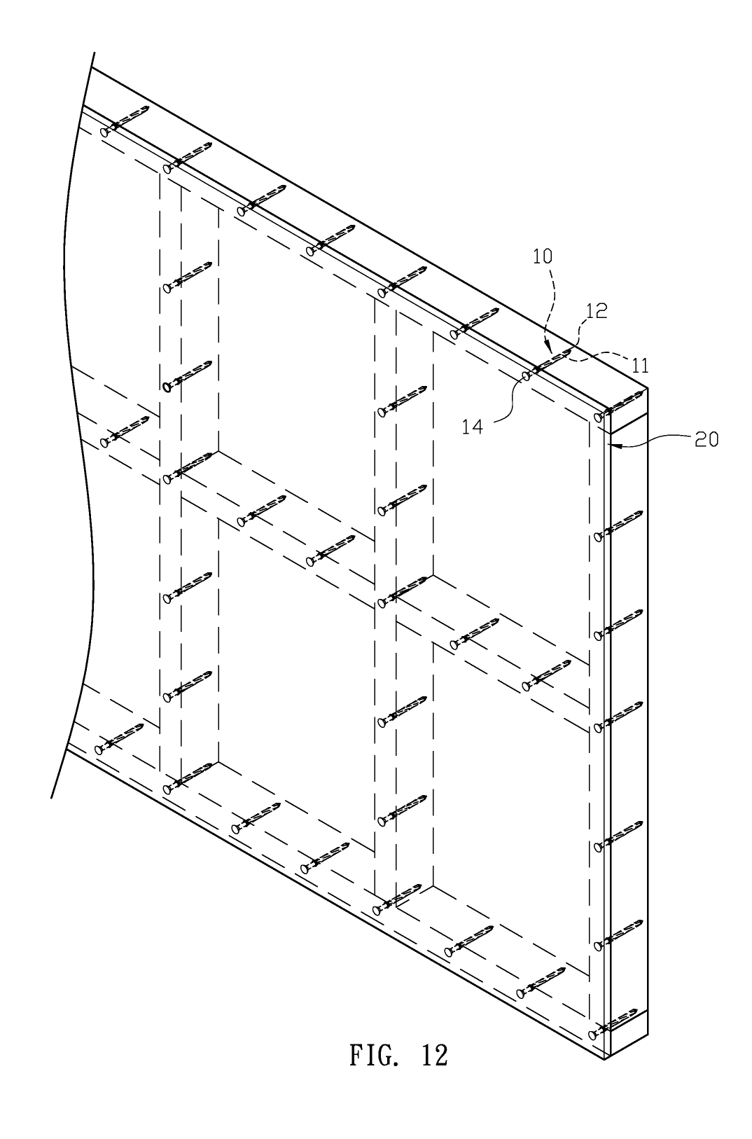

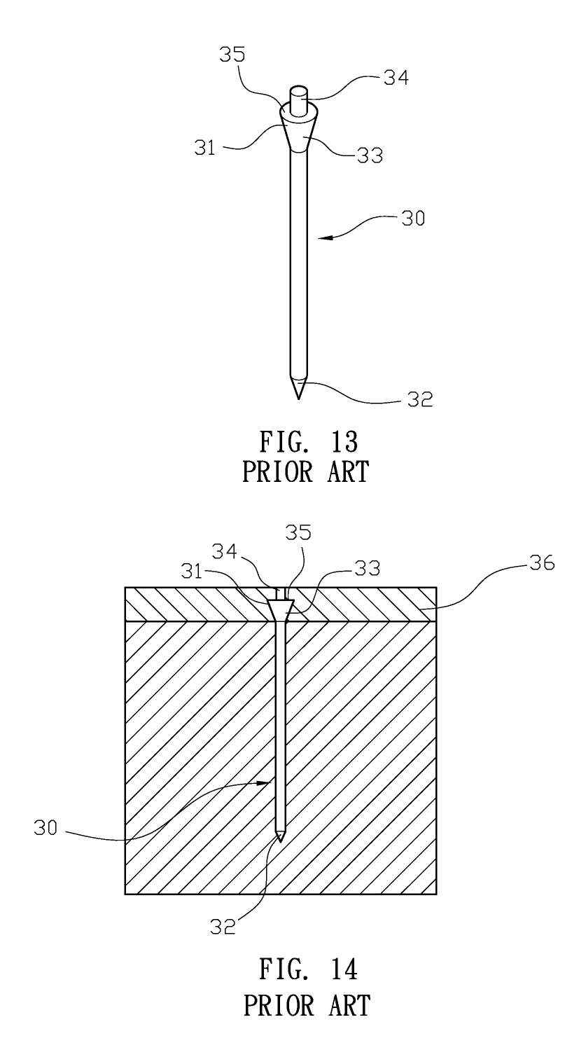

In a preferred embodiment shown in FIGS. 10 and 11, the main body can be a nail for decoration used in calcium silicate or plastic synthetic boards to secure the fixed unit (20). The head end (14) is tapered from top to bottom like a flipped cone and the head end itself is flat. When the main body (10) passes through the fixed unit (20) and is secured in the wall or structure, the head end (14) can be buried so that the surface of the fixed unit (20) remains flat (see FIG. 12). In other words, the head end (14) does not appear to reduce the aesthetic value of the wall as a whole after decoration.

According to the structure in the abovementioned embodiments, the present invention is advantageous that when the main body (10) passes through the fixed unit (20) to attach to the wall or structure, the slanting threads on the long section (11) generates an engaging status. Also, when the ring end (13) is inserted into the wall or structure, it provides a stopping effect, so that the main body (10) is not easy to pull out from the wall or structure. The head end (14) is restricted by the fixed unit (20) towards the wall or structure, so the fixed unit (20) can be securely fixed to enhance the practicability of the nail structure.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A nail structure comprising a main body that includes a long section having a surface with slanting threads thereon, and one end of the long section has a sharp end, while the other end has an enlarging ring end with cone shape, wherein one end of the main body has a head end, and a neck section is formed between the head end and ring end.

2. The nail structure of claim 1, wherein length of the neck section of the main body is determined according to thickness of a fixed unit.

3. The nail structure of claim 1, wherein the head end of the main body is tapered from top to bottom with a flipped cone shape, and a terminal thereof is flat.
